(19) United States
(12) Patent Application Publication
(10) Pub. No.: US 2006/0238437 A1
(43) Pub. Date: Oct. 26, 2006

(54) Antenna with isolation sleeve

(76) Inventor: Chung-Chuan Huang, Yuan Kan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/110,663

(22) Filed: Apr. 21, 2005

(51) Int. Cl. H01Q 1/50

(52) U.S. Cl. 343/906; 343/900

(57) ABSTRACT

An antenna includes a body with an isolation sleeve fitted in the stepped passage defined axially through the body. A central signal line is received in the isolation sleeve. A connector is rotatably connected to an end of the body and a flange extends inward from an inner periphery of the connector. A portion of the isolation sleeve and the central signal line in the isolation sleeve extend through the connector. A spring is mounted to the isolation sleeve and biased between the flange and a race mounted on the isolation sleeve. The isolation sleeve prevents the change of the magnetic fields to the central signal line.

### FIELD OF THE INVENTION

The present invention relates to an antenna having an isolation sleeve encompassing the central signal line.

### BACKGROUND OF THE INVENTION

Conventional antennas are used on radios, remote controls and receivers to receive electromagnetic signals. Modern antennas are able to received signals from 1.00 GHz to 6.00 GHz. For the antenna that is able to receives signals from 1.00 GHz to 6.00 GHz generally includes a body and a central signal line is received in the body. The central signal line includes multiple sections which are connected with each other and the antenna has a positive pole and a negative pole on two ends thereof.

However, the conventional antennas are found not to be able to receive the signals as clear as expected. This is because when electric current passes through the central signal line, the magnetic fields changes dramatically and the change affects the quality of the receive for signals. Besides, the efficiency of receiving of signals of the central signal line drops when the earth line of the antennas guides statistic electricity to the earth.

The present invention intends to provide an antenna that includes an isolation sleeve encompasses the central signal line to avoid the shortcomings of the conventional antennas.

### SUMMARY OF THE INVENTION

The present invention relates to an antenna which comprises a body having a stepped passage defined axially therethrough and an isolation sleeve is fitted in the stepped passage. A central signal line is received in the isolation sleeve. A connector is rotatably connected to an end of the body and a flange extends inward from an inner periphery of the connector. A portion of the isolation sleeve and the central signal line in the isolation sleeve extend through the connector. A spring is mounted to the isolation sleeve and a first end of the spring contacts against the flange and a second end of the spring is in contact with a race mounted on the isolation sleeve.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the antenna of the present invention, and

FIG. 2 is a cross sectional view of the antenna of the present invention.

### DETAILED DESCRIPTION OF THE PREFERRED EMBODIMENT

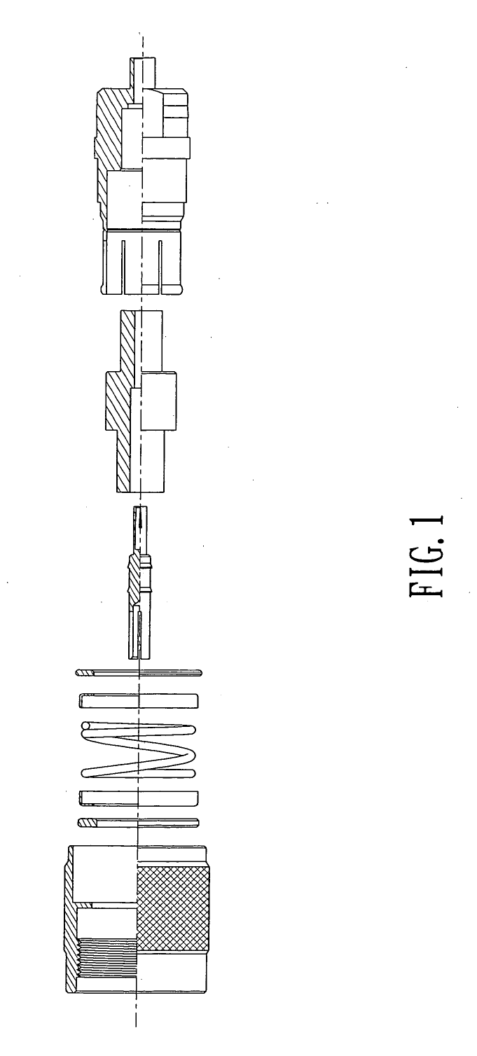

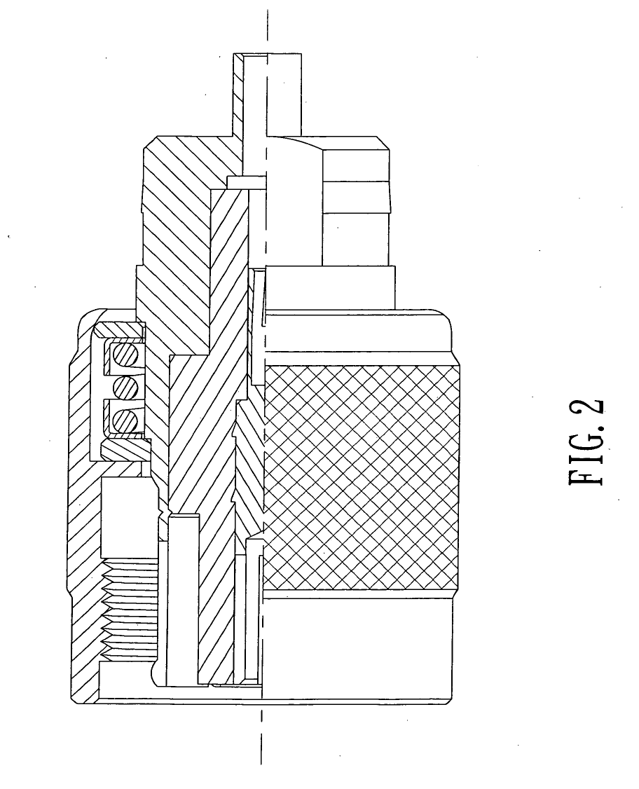

Referring to FIGS. 1 and 2, the antenna of the present invention comprises an elongate body 1 with a stepped passage 11 defined axially therethrough and an isolation sleeve 12 is fitted in the stepped passage 11. A central signal line 13 is received in the isolation sleeve 12 and completely encompassed by the isolation sleeve 12. The central signal line 13 is made by metal and includes several sections.

A connector 2 is rotatably connected to an end of the body 1 and a flange 21 extends inward from an inner periphery of the connector 2. A receiving space 22 is defined in the connector 2 and ends at the flange 21. A portion of the isolation sleeve 12 and the central signal line 13 in the isolation sleeve 12 extend through the connector 2. A spring 3 is mounted to the isolation sleeve 12 and a plurality of races 31 are received in the receiving space 22 and retains the spring 3. A first end of the spring 3 contacts against the flange 21 and a second end of the spring 3 is in contact with one of the races 31 which is stopped by an end of the connector 2 and an outward shoulder of the isolation sleeve 12.

The central signal line 13 is isolated by the isolation sleeve 12 so that the change of magnetic field to the central signal line 13 is avoided and this important feature helps to increase the receiving quality of the central signal line 13. Due to the isolation, no interruption to the central signal line 13 when statistic electricity is guided to the earth.

While we have shown and described the embodiment in accordance with the present invention, it should be clear to those skilled in the art that further embodiments may be made without departing from the scope of the present invention.

What is claimed is:

1. An antenna comprising:
a body having a stepped passage defined axially therethrough and an isolation sleeve fitted in the stepped passage, a central signal line is received in the isolation sleeve;
a connector rotatably connected to an end of the body and a flange extending inward from an inner periphery of the connector, a portion of the isolation sleeve and the central signal line in the isolation sleeve extending through the connector, and
a spring mounted to the isolation sleeve and a first end of the spring contacting against the flange and a second end of the spring being in contact with a race mounted on the isolation sleeve.
